(19) United States
(12) Patent Application Publication
(10) Pub. No.: US 2011/0224355 A1
(43) Pub. Date: Sep. 15, 2011

(54) THERMOPLASTIC RESIN COMPOSITION FOR VEHICULAR LAMP HOUSING

(75) Inventors: Hajime Tomita, Osaka (JP); Tokuo Tatsuda, Ehime (JP); Tetsuya Yamamoto, Ehime (JP); Seiji Tamai, Ehime (JP)

(73) Assignee: NIPPON A&L INC., Osaka-shi, Osaka (JP)

(21) Appl. No.: 13/062,968

(22) PCT Filed: Sep. 9, 2009
(86) PCT No.: PCT/JP2009/065724

§ 371 Date: May 25, 2011

(30) Foreign Application Priority Data
Sep. 10, 2008 (JP) 2008-232087
Jun. 12, 2009 (JP) 2009-140918

(51) Int. Cl. C08L 51/04; C08L 51/00; B82Y 30/00

(52) U.S. Cl. 524/504; 525/73; 525/71; 977/773

(57) ABSTRACT

The present invention provides a thermoplastic resin composition for a vehicular lamp housing, which is excellent in balance of physical properties with regard to such as impact resistance and fluidity, and of which hot plate weldability, vibration weldability and laser weldability are improved when a vehicular lamp housing is welded with other members.

A thermoplastic resin composition for a vehicular lamp housing, comprising a graft copolymer (A) and a (co)polymer (C) is provided, wherein
the graft copolymer (A) is obtained by emulsion graft polymerization of an acrylic acid ester-based rubbery polymer having a weight average particle diameter of 70 to 250 nm with at least one monomer selected from the group consisting of an aromatic vinyl-based monomer, a vinyl cyanide-based monomer, a (meth)acrylic acid ester-based monomer and a maleimide-based monomer, wherein the acrylic acid ester-based rubbery polymer is obtained by emulsion polymerization of 60 to 95% by weight of an acrylic acid ester-based monomer in the presence of 5 to 40% by weight of an aromatic vinyl-based polymer having a weight average particle diameter of 10 to 150 nm;
the (co)polymer (C) is obtained by polymerization of at least one monomer selected from the group consisting of an aromatic vinyl-based monomer, a vinyl cyanide-based monomer, a (meth)acrylic acid ester-based monomer and a maleimide-based monomer.

### TECHNICAL FIELD

The present invention relates to a thermoplastic resin composition for a vehicular lamp housing. More particularly, the present invention relates to a thermoplastic resin composition for a vehicular lamp housing, which is excellent in an improvement in stringing property when a hot plate welding method is used, excellent in suppression of the generation of burrs when a vibration welding method is used and excellent in weldability when a laser welding method is used in the case where a vehicular lamp housing produced by using the resin composition is welded with other members such as lens made of a resin, and also excellent in balance of physical properties with regard to such as impact resistance, fluidity, gloss and color development property.

### BACKGROUND ART

When a vehicular lamp housing is bonded with a lens made of a resin, a hot plate welding method, a vibration welding method or a laser welding method is commonly used.

According to these welding methods, the vehicular lamp housing is bonded with the lens made of a resin by applying vibration to a bonding surface of the vehicular lamp housing, pressing the vehicular lamp housing against a hot mold, or melting the vehicular lamp housing through irradiation with laser beams.

In the hot plate welding method, when the vehicular lamp housing is melted by a hot plate and then separated from the hot plate, the resin of the vehicular lamp housing is stretched into a string-like shape (hereinafter referred to as “stringing property”) and adheres on a surface of a vehicular lamp housing molded article thereby causing a problem such as deterioration of appearance of a vehicular lamp molded article.

In the vibration welding method, the melted resin of the vehicular lamp housing protrudes from the weld portion between the lamp housing and other members (so-called burrs) thereby causing a problem such as deterioration of appearance of a vehicular lamp molded article, similar to the hot plate welding method.

In the laser welding method, when the bond portion between the lamp housing and other members is irradiated with laser beams, the resin at the side irradiated with laser beams is melted thereby causing a problem such as fuming.

For example, Patent Document 1 discloses that problems occurred when welding is performed using each method can be solved by adjusting the gel content of a thermoplastic resin to 70% or more. Furthermore, Patent Document 2 discloses that burrs generated when welding is performed using a vibration welding method can be suppressed by using a thermoplastic resin composition containing a crosslinked acrylic rubber. Patent Document 3 discloses that weldability when welding is performed using a laser welding method can be improved by using a thermoplastic resin in which the content of an alkali metal is a predetermined quantity or less. Patent Document 4 discloses that, when a thermoplastic resin containing polyorganosiloxane and having a specific reduced viscosity is used, the obtained molded article has satisfactory appearance and burrs are not generated when welding is performed using a vibration welding method.

However, a thermoplastic resin composition which enables an improvement in weldability according to each welding method, and is also excellent in physical property balance with regard to such as impact resistance and fluidity, and more preferably further physical property balance with regard to such as gloss and color development property is needed. More preferably a thermoplastic resin composition which is excellent in entire physical properties such as impact resistance, fluidity, gloss and color development property is needed.
Patent Document 1: JP 2004-182835 A
Patent Document 2: JP 2005-112991 A
Patent Document 3: JP 2007-8974 A
Patent Document 4: JP 2007-91969 A

### DISCLOSURE OF THE INVENTION

### Problems to be Solved by the Invention

An object of the present invention is to provide a thermoplastic resin composition for a vehicular lamp housing, which is excellent in an improvement in stringing property when a hot plate welding method is used, excellent in suppression of the generation of burrs when a vibration welding method is used and excellent in weldability when a laser welding method is used in the case where a vehicular lamp housing is welded with other members, and also excellent in physical property balance with regard to such as impact resistance and fluidity, and more preferably further physical property balance with regard to such as gloss and color development property.

### Means for Solving the Problems

The present invention provides, in one aspect, a novel thermoplastic resin composition for a vehicular lamp housing, which comprises:

a graft copolymer (A) and a (co)polymer (C) shown below, wherein

the graft copolymer (A) is obtained by emulsion graft polymerization of an acrylic acid ester-based rubbery polymer (a-1-2) having a weight average particle diameter of 70 to 250 nm with at least one monomer (a-2) selected from the group consisting of an aromatic vinyl-based monomer, a vinyl cyanide-based monomer, a (meth)acrylic acid ester-based monomer and a maleimide-based monomer, wherein the acrylic acid ester-based rubbery polymer (a-1-2) is obtained by emulsion polymerization of 60 to 95% by weight of an acrylic acid ester-based monomer in the presence of 5 to 40% by weight of an aromatic vinyl-based polymer (a-1-1) having a weight average particle diameter of 10 to 150 nm (provided that percentage(s) by weight is based on the acrylic acid ester-based rubbery polymer (a-1-2) (100% by weight));

the (co)polymer (C) is obtained by polymerization of at least one monomer selected from the group consisting of an aromatic vinyl-based monomer, a vinyl cyanide-based monomer, a (meth)acrylic acid ester-based monomer and a maleimide-based monomer;

the thermoplastic resin composition contains 5 to 95 parts by weight of the graft copolymer (A) and 5 to 95 parts by weight of the (co)polymer (C) (provided that part(s) by weight is based on the total of (A) and (C) (100 parts by weight)); and

the content of the acrylic acid ester-based rubbery polymer (a-1-2) is from 5 to 30% by weight of (provided that percentage(s) by weight is based on the resin composition (100% by weight)).

The present invention provides, in another aspect, a thermoplastic resin composition for a vehicular lamp housing, which comprises:

a graft copolymer (A), a graft copolymer (B) and a (co)polymer (C) shown below, wherein

the graft copolymer (A) is obtained by emulsion graft polymerization of an acrylic acid ester-based rubbery polymer (a-1-2) having a weight average particle diameter of 70 to 250 nm with at least one monomer (a-2) selected from the group consisting of an aromatic vinyl-based monomer, a vinyl cyanide-based monomer, a (meth)acrylic acid ester-based monomer and a maleimide-based monomer, wherein the acrylic acid ester-based rubbery polymer (a-1-2) is obtained by emulsion polymerization of 60 to 95% by weight of an acrylic acid ester-based monomer in the presence of 5 to 40% by weight of an aromatic vinyl-based polymer (a-1-1) having a weight average particle diameter of 10 to 150 nm (provided that percentage(s) by weight is based on the acrylic acid ester-based rubbery polymer (a-1-2) (100% by weight));

the graft copolymer (B) is obtained by graft polymerization of a butadiene-based rubber polymer (b-1) having a weight average particle diameter of 150 to 400 nm with at least one monomer (b-2) selected from the group consisting of an aromatic vinyl-based monomer, a vinyl cyanide-based monomer, a (meth)acrylic acid ester-based monomer and a maleimide-based monomer;

the (co)polymer (C) is obtained by polymerization of at least one monomer selected from the group consisting of an aromatic vinyl-based monomer, a vinyl cyanide-based monomer, a (meth)acrylic acid ester-based monomer and a maleimide-based monomer;

the thermoplastic resin composition contains 5 to 90 parts by weight of the graft copolymer (A), 5 to 90 parts by weight of the graft copolymer (B) and 5 to 90 parts by weight of the (co)polymer (C) (provided that part(s) by weight is based on the total of (A), (B) and (C) (100 parts by weight)); and

the total of the content of the acrylic acid ester-based rubbery polymer (a-1-2) and the content of the butadiene-based rubber polymer (b-1) is from 5 to 30% by weight (provided that percentage(s) by weight is based on the resin composition (100% by weight)).

### Effects of the Invention

The use of the thermoplastic resin composition for a vehicular lamp housing of the present invention makes it possible to obtain a vehicular lamp housing, which enables an improvement in stringing property when a hot plate welding method is used, in burrs generated when a vibration welding method is used and in weldability when a laser welding method is used in the case where a vehicular lamp housing is welded with other members, and is also excellent in physical property balance with reagard to such as impact resistance and fluidity, and more preferably further physical property balance with regard to such as gloss and color development property, and to obtain a vehicular lamp molded article.

### EMBODIMENTS FOR CARRYING OUT THE INVENTION

The present invention will be explained in detail.

First, a graft copolymer (A) according to inventions of one aspect and another aspect will be explained.

The “graft copolymer (A)” can be obtained by emulsion graft polymerization of an acrylic acid ester-based rubbery polymer (a-1-2) having a weight average particle diameter of 70 to 250 nm (hereinafter may also be referred to as a “polymer (a-1-2)”) with at least one monomer (a-2) selected from the group consisting of an aromatic vinyl-based monomer, a vinyl cyanide-based monomer, a (meth)acrylic acid ester-based monomer and a maleimide-based monomer.

The “polymer (a-1-2)” can be obtained by emulsion polymerization of 60 to 95% by weight of an acrylic acid ester-based monomer in the presence of 5 to 40% by weight of an aromatic vinyl-based polymer (a-1-1) having a weight average particle diameter of 10 to 150 nm (hereinafter may also be referred to as a “polymer (a-1-1)”). Herein, percentage(s) by weight of the polymer (a-1-1) and percentage(s) of the acrylic acid ester-based monomer are based on the polymer (a-1-2) (100% by weight)).

The “polymer (a-1-1)” is a polymer obtained by radical polymerization of a monomer containing an aromatic vinyl-based monomer as an essential component, and can be obtained by polymerization of only the aromatic vinyl-based monomer or radical polymerization of other vinyl-based monomers copolymerizable with the aromatic vinyl-based monomer.

Examples of the “aromatic vinyl-based monomer” include styrene, α-methylstyrene, p-methylstyrene, t-butylstyrene and dimethylstyrene, which can be used alone or in combination. Styrene is particularly preferred as the aromatic vinyl-based monomer.

Examples of “copolymerizable other vinyl-based monomers” include acrylic acid ester-based monomers such as methyl acrylate, ethyl acrylate, propyl acrylate, butyl acrylate and 2-ethylhexyl acrylate; methacrylic acid ester-based monomers such as methyl methacrylate, ethyl methacrylate, propyl methacrylate and butyl methacrylate; vinyl cyanide-based monomers such as acrylonitrile and methacrylonitrile; maleimide-based monomers such as maleimide and N-phenylmaleimide; unsaturated carboxylic acids such as acrylic acid, methacrylic acid, itaconic acid and maleic acid; unsaturated carboxylic anhydrides such as maleic anhydride and itaconic anhydride; unsaturated epoxy-based monomers such as glycidyl methacrylate and allyl glycidyl ether; and hydroxyl group-containing unsaturated monomers such as hydroxyethyl acrylate and hydroxyethyl methacrylate, which can be used alone or in combination. Acrylic acid ester-based monomers and vinyl cyanide-based monomers are particularly preferred as “copolymerizable other vinyl-based monomers”.

Regarding the aromatic vinyl-based polymer (a-1-1), the proportion of a monomer to be used is not particularly limited as long as the objective thermoplastic resin composition of the present invention can be obtained. However, the polymer (a-1-1) is preferably a polymer obtained by polymerization of a monomer containing 40 to 90% by weight of an aromatic vinyl-based monomer and 10 to 60% by weight of an acrylic acid ester-based monomer (provided that percentage(s) by weight is based on the total of the aromatic vinyl-based monomer and the acrylic acid ester-based monomer (100% by weight)), or preferably a polymer obtained by polymerization of a monomer containing 40 to 90% by weight of an aromatic vinyl-based monomer and 10 to 60% by weight of a vinyl cyanide-based monomer (provided that percentage(s) by weight is based on the total of the aromatic vinyl-based monomer and the vinyl cyanide-based monomer (100% by weight)). When these polymers are used, balance of physical properties with regard to such as impact resistance and fluidity is more improved.

It is necessary that a weight average particle diameter of the “aromatic vinyl-based polymer (a-1-1)” is from 10 to 150 nm. When the weight average particle diameter of the polymer (a-1-1) is less than 10 nm, it is not preferred because of poor vibration weldability. When the weight average particle diameter is more than 150 nm, it is not preferred because of poor physical property balance with regard to gloss, impact resistance, fluidity and color development property, and poor vibration weldability, hot plate weldability and laser weldability.

The aromatic vinyl-based polymer (a-1-1) can be produced by using known polymerization methods, for example, an emulsion polymerization method, a solution polymerization method, a suspension polymerization method and a bulk polymerization method. It is particularly preferred to use an emulsion polymerization method.

The weight average particle diameter can be easily controlled within a range from 10 to 150 nm by adjusting the kind and proportion of auxiliary agents such as an emulsifier and a polymerization initiator, and the polymerization time when the aromatic vinyl-based polymer (a-1-1) is polymerized.

The acrylic acid ester-based rubbery polymer (a-1-2) can be obtained by emulsion polymerization of 60 to 95% by weight of an acrylic acid ester-based monomer in the presence of 5 to 40% by weight of the aromatic vinyl-based polymer (a-1-1) (provided that percentage(s) by weight is based on the acrylic acid ester-based rubbery polymer (a-1-2) (100% by weight)) and the weight average particle diameter is from 70 to 250 nm.

Specifically, the acrylic acid ester-based rubbery polymer (a-1-2) can be obtained by emulsion polymerization of an aromatic vinyl-based polymer (a-1-1) with an acrylic acid ester-based monomer, if necessary, in the presence of a crosslinking agent.

Examples of the acrylic acid ester-based monomer include methyl acrylate, ethyl acrylate, propyl acrylate, butyl acrylate and 2-ethylhexyl acrylate, which can be used alone or in combination.

Examples of the crosslinking agent include divinylbenzene, allyl (meth)acrylate, ethylene glycol di(meth)acrylate, diallyl phthalate, dicyclopentadiene di(meth)acrylate, trimethylolpropane tri(meth)acrylate, pentaerythritol hexa(meth)acrylate, 1,4-butanediol di(meth)acrylate, 1,6-hexanediol di(meth)acrylate, triallyl cyanurate and triallyl isocyanurate.

(Meth)acrylate means both acrylate and methacrylate.

Known emulsifiers can be used as an emulsifier used for emulsion polymerization and examples thereof include anionic emulsifiers such as sodium dodecylbenzene sulfonate, sodium oleate and potassium alkenyl succinate; and nonionic emulsifiers such as polyoxyethylene nonyl phenyl ether.

Known polymerization initiators can be used as a polymerization initiator used for emulsion polymerization. It is possible to use inorganic initiators (for example, persulfates such as potassium persulfate, sodium persulfate and ammonium persulfate); organic peroxides such as t-butyl hydroxyperoxide and cumen hydroxyperoxide; and azo compounds alone, or to use redox-based initiators in which the organic peroxides are used in combination with reducing agent components such as sulfite and sodium formaldehyde sulfoxylate. If necessary, polymerization chain transfer agents such as t-dodecylmercaptane can be used.

The acrylic acid ester-based rubbery polymer (a-1-2) has a weight average particle diameter of 70 to 250 nm. When the weight average particle diameter is less than 70 nm, it is not preferred because of poor physical property balance with regard to such as impact resistance, fluidity, gloss, color development property, and poor hot plate weldability, laser weldability and vibration weldability. When the weight average particle diameter is more than 250 nm, it is not preferred because of poor laser weldability and color development property.

The weight average particle diameter of the acrylic acid ester-based rubber polymer (a-1-2) can be easily controlled within a range from 70 to 250 nm by adjusting the ratio of the aromatic vinyl-based polymer (a-1-1) to the acrylic acid ester-based monomer, amount of the emulsifier and polymerization time, taking the weight average particle diameter of the aromatic vinyl-based polymer (a-1-1) into consideration when the acrylic acid ester-based rubber polymer (a-1-2) is polymerized.

In the case of obtaining the acrylic acid ester-based rubbery polymer (a-1-2), when the used amount of the aromatic vinyl-based polymer (a-1-1) is less than 5% by weight, color development property, vibration weldability and laser weldability are poor. When the used amount is more than 40% by weight, gloss, vibration weldability and hot plate weldability are poor.

The graft copolymer (A) can be obtained by emulsion graft polymerization of the acrylic acid ester-based rubbery polymer (a-1-2) thus obtained with at least one monomer (a-2) selected from the group consisting of an aromatic vinyl-based monomer, a vinyl cyanide-based monomer, a (meth)acrylic acid ester-based monomer and a maleimide-based monomer.

The graft copolymer (A) is particularly preferably a graft copolymer obtained by grafting the polymer (a-1-2) with an aromatic vinyl-based monomer and a vinyl cyanide-based monomer, or a graft copolymer obtained by grafting the polymer (a-1-2) with an aromatic vinyl-based monomer and a (meth)acrylic acid ester-based monomer, or a graft copolymer obtained by grafting a polymer (a-1-2) with an aromatic vinyl-based monomer, a vinyl cyanide-based monomer and a (meth)acrylic acid ester-based monomer.

Examples of the aromatic vinyl-based monomer which can be selected as the monomer (a-2) include styrene, α-methylstyrene, p-methylstyrene, t-butylstyrene and dimethylstyrene, which can be used alone or in combination. Among these monomers, styrene is particularly preferred.

Examples of the vinyl cyanide-based monomer include acrylonitrile and methacrylonitrile, which can be used alone or in combination. Among these monomers, acrylonitrile is particularly preferred.

Examples of the (meth)acrylic acid ester-based monomer include methyl (meth)acrylate, 2-ethylhexyl (meth)acrylate, ethyl (meth)acrylate and butyl (meth)acrylate, which can be used alone or in combination.

Examples of the maleimide-based monomer include maleimide, methylmaleimide, ethylmaleimide and N-phenylmaleimide, which can be used alone or in combination.

In the present invention, as long as the effects thereof are not adversely affected, the above monomers can be used in combination with copolymerizable other vinyl-based monomers, for example, unsaturated carboxylic acids or anhydrides thereof (for example, acrylic, methacrylic and maleic anhydrides) and amide-based monomers (for example, acrylamide and methacrylamide). These monomers can be used alone or in combination.

The ratio of the acrylic acid ester-based rubbery polymer (a-1-2) to the monomer (a-2) is not particularly limited as long as the objective resin composition of the present invention can be obtained. It is preferred that the proportion of the rubbery polymer (a-1-2) is preferably from 5 to 80% by weight and that of the monomer (a-2) is preferably from 95 to 20% by weight (based on the graft copolymer (A) (100% by weight)).

A graft ratio of the graft copolymer (A) is not particularly limited as long as the objective resin composition of the present invention can be obtained, but is preferably from 20 to 150%, taking physical property balance of impact resistance into consideration. In the case of emulsion polymerization of the graft copolymer (A), a known emulsion polymerization method can be employed. Known emulsifiers and polymerization initiators can be used as the emulsifier and polymerization initiator used for the emulsion polymerization.

Next, a graft copolymer (B) according to an invention of another aspect will be explained.

The graft copolymer (B) can be obtained by graft polymerization of a butadiene-based rubber polymer (b-1) having a weight average particle diameter of 150 to 400 nm with at least one monomer (b-2) selected from the group consisting of an aromatic vinyl-based monomer, a vinyl cyanide-based monomer, a (meth)acrylic acid ester-based monomer and a maleimide-based monomer.

The graft copolymer (B) is particularly preferably a graft copolymer obtained by grafting a butadiene-based rubber polymer (b-1) with an aromatic vinyl-based monomer and a vinyl cyanide-based monomer, or a graft copolymer obtained by grafting a butadiene-based rubber polymer (b-1) with an aromatic vinyl-based monomer and a (meth)acrylic acid ester-based monomer, or a graft copolymer obtained by grafting a butadiene-based rubber polymer (b-1) with an aromatic vinyl-based monomer, a vinyl cyanide-based monomer and a (meth)acrylic acid ester-based monomer.

The butadiene-based rubber polymer (b-1) constituting the graft copolymer (B) can be obtained by radical polymerization of a monomer containing 50% by weight or more of a butadiene-based monomer such as 1,3-butadiene and isoprene. Specific examples of the butadiene-based rubber polymer (b-1) include polybutadiene, polyisoprene, a butadiene-styrene copolymer, a butadiene-acrylonitrile copolymer and a butadiene-methyl methacrylate copolymer.

Examples of the aromatic vinyl-based monomer which can be selected as the monomer (b-2) graft-polymerizable with the butadiene-based rubber polymer (b-1) include styrene; examples of the vinyl cyanide-based monomer include acrylonitrile; and examples of the unsaturated carboxylic acid alkyl ester-based monomer include methyl acrylate, ethyl acrylate and methyl methacrylate.

The butadiene-based rubber polymer (b-1) has a weight average particle diameter within a range from 150 to 400 nm. When the weight average particle diameter is less than 150 nm, it is not preferred since physical property balance with regard to such as impact resistance, gloss, color development property and thermostability may be poor, and vibration weldability, hot plate weldability, laser weldability and thermostability may be poor. When the weight average particle diameter is more than 400 nm, it is not preferred since color development property and laser weldability may be poor. The weight average particle diameter is preferably within a range from 250 to 400 nm in view of impact resistance and thermostability.

As the butadiene-based rubber polymer (b-1), the rubber polymer having a weight average particle diameter of 150 to 400 nm (hereinafter referred to as an “un-aggregated and un-enlarged rubber polymer”) may be used as it is, or a polymer obtained (hereinafter referred to as an “aggregated and enlarged rubber polymer”) by enlarging a rubber polymer, which can be used as a material for aggregating and enlarging particles (hereinafter referred to as a “rubber polymer for aggregation and enlargement”), may also be used. Specifically, the rubber polymer (b-1) may contain a butadiene-based rubber polymer aggregated and enlarged so that the weight average particle diameter of a butadiene-based rubber polymer for aggregation and enlargement, having a weight average particle diameter of 50 to 200 nm, becomes 150 to 400 nm, together with the above un-aggregated and un-enlarged rubber polymer, or alone. The aggregated and enlarged rubber polymer is preferred in view of bronze appearance.

Herein, “aggregation and enlargement” of the un-aggregated and un-enlarged rubber polymer means that the weight average particle diameter is increased.

The rubber polymer having a weight average particle diameter of 150 to 200 nm may be used as the un-aggregated and un-enlarged rubber polymer as it is in the rubber polymer (b-1) and/or used as a rubber polymer for aggregation and enlargement to obtain an aggregated and enlarged rubber polymer having an increased weight average particle diameter of more than 150 nm and 400 nm or less, and the obtained aggregated and enlarged rubber polymer may be used in the rubber polymer (b-1).

The butadiene-based rubber polymer for aggregation and enlargement, and the un-aggregated and un-enlarged rubber polymer can be produced by emulsion polymerization using a common method for producing a rubber polymer as long as the objective resin composition can be obtained.

It is possible to use, as the emulsifier used in the production, a surfactant containing a weak acid-strong base type salt such as fatty acid soaps, which loses an emulsifying action in an acidic range of pH 7 or lower. More specifically, a sodium salt and/or a potassium salt of one, or two or more acids selected from lauric acid, oleic acid, stearic acid, mixed fatty acid and disproportionated rosin acid can be exemplified. Examples of particularly preferred emulsifier include, but are not limited to, a potassium salt or a sodium salt of oleic acid, and a potassium salt or a sodium salt of disproportionated rosin acid.

The used amount of the emulsifier is not particularly limited, but is preferably from 1.0 to 5.0 parts by weight based on 100 parts by weight of the total of the butadiene-based monomer and copolymerizable other monomers.

When the butadiene-based rubber polymer for aggregation and enlargement, and the un-aggregated and un-enlarged rubber polymer are produced by known emulsion polymerization using the above surfactant as the emulsifier, conventional polymerization auxiliary agents such as initiators, molecular weight modifiers and electrolytes can also be used.

Examples of the initiator include persulfates such as potassium persulfate, sodium persulfate and ammonium persulfate and/or, redox-based initiators in which the organic peroxides such as t-butylhydroxy peroxide and cumen hydroxyperoxide are used in combination with reducing agent components such as sulfite and sodium formaldehyde sulfoxylate, namely, combinations of persulfates and reducing agent components, combinations of organic peroxides and reducing agent components, and combinations of persulfates, organic peroxides and reducing agent components.

Examples of the molecular weight modifier include mercaptans (t-dodecylmercaptan and n-dodecylmercaptan), terpinolene and α-methylstyrene dimer.

Examples of the electrolyte include basic substances such as sodium hydroxide, potassium hydroxide and ammonium hydroxide; sodium chloride, potassium sulfate, sodium acetate, sodium sulfate, potassium phosphate and tetrapotassium pyrophosphate, which can be used alone or in combination.

The polymerization temperature is not particularly limited, and is preferably within a range from 50 to 80° C.

The butadiene-based rubber polymer for aggregation and enlargement, and the un-aggregated and un-enlarged rubber polymer can be obtained by emulsion polymerization. Alternatively, they can be obtained by emulsifying a separately polymerized solid rubbery polymer in the presence of the above surfactant using a homogenizer.

It is possible to use, as a method for aggregating and enlarging the thus obtained butadiene-based rubber polymer for aggregation and enlargement, conventionally known methods, for example, methods of adding an acidic substance (see, for example, JP 42-3112 B, JP 55-19246 B, JP 2-9601 B, JP 63-117005 A, JP 63-132903 A, JP 7-157501 A and JP 8-259777 A), and methods of using an acid group-containing latex (JP 56-166201 A, JP 59-93701 A, JP 1-126301 A and JP 8-59704 A).

As long as the objective resin composition of the present invention is obtained, the method for aggregation and enlargement is not particularly limited. The aggregated and enlarged rubber polymer can be obtained by adding an acidic substance to a butadiene-based rubber polymer latex for aggregation and enlargement thereby making the pH of the latex to be lower than 7, aggregating and enlarging the latex thereby adjusting to a predetermined weight average particle diameter, and adding a basic substance thereby making the pH to be higher than 7 and stabilizing the obtained polymer. It is preferred to use the thus obtained butadiene-based rubber polymer since it is excellent in balance with regard to impact resistance and gloss.

The butadiene-based rubber polymer latex for aggregation and enlargement can be aggregated and enlarged by bringing into contact with an acidic substance. Examples of the acidic substance include mineral acids such as sulfuric acid, hydrochloric acid and phosphoric acid; acidic salts such as sodium hydrogen sulfate and sodium dihydrogen phosphate; organic acids such as oxalic acid, citric acid, acetic acid and formic acid; and acid anhydrides such as acetic anhydride. Phosphoric acid, sulfuric acid, acetic anhydride and acetic acid are particularly preferred. Two or more kinds of these acidic substances may be used in combination.

The used amount of the acidic substance may be an amount required to make the rubber polymer latex to be acidic (pH 7 or lower) and is appropriately adjusted according to the particle diameter of the rubber polymer latex to be enlarged, kind and amount of the emulsifier, and particle diameter of the objective enlarged rubber polymer latex. Basically, the acidic substance is preferably diluted with deionized water and added in a state of an aqueous solution, and the concentration is not particularly limited. In order to prevent a drastic decrease in the solid content of the aggregated and enlarged rubber polymer latex and to prevent the generation of an aggregate and adhesion of the rubber polymer latex to an apparatus, the used amount of the acidic substance is preferably from 0.3 to 10 parts by weight, and particularly preferably from 0.5 to 5.0 part by weight, based on 100 parts by weight (in terms of the solid content) of the rubber polymer latex.

Before the addition of the acidic substance, an acidic surfactant having satisfactory surface activity may be preliminarily added to the butadiene-based rubber polymer latex for aggregation and enlargement, if necessary. Preliminary addition of the acidic surfactant having satisfactory surface activity makes it easy to control the particle diameter of the latex upon aggregation and enlargement.

Examples of the surfactant which is acidic and has satisfactory surface activity include sodium alkyl benzene sulfonate, sodium alkyl naphthalene sulfonate, potassium alkyl diphenyl ether sulfonate and sodium lauryl sulfate. The addition amount is not particularly limited, but can be appropriately adjusted according to the concentration of the acidic substance to be used for aggregation and enlargement, and kind and solid content of the butadiene-based rubber polymer latex for aggregation and enlargement. The addition amount is preferably 0.3 part by weight or less based on 100 parts by weight (in terms of the solid content) of the butadiene-based rubber polymer latex for aggregation and enlargement. After aggregation and enlargement, the pH of the aggregated and enlarged rubber polymer latex is preferably adjusted to 7 or higher, and more preferably 8 to 11 by adding a basic substance to the aggregated and enlarged rubber polymer latex in view of mechanical stability of the aggregated and enlarged rubber polymer latex, in other words, prevention of the generation of an aggregate.

Examples of the basic substance include sodium hydroxide and potassium hydroxide, which can be used alone or in combination. Basically, the basic substance is preferably diluted with deionized water and added in a state of an aqueous solution, and the concentration is not particularly limited. In order to prevent a drastic decrease in the solid content of the aggregated and enlarged rubber polymer latex and to prevent the generation of an aggregate and adhesion of the rubber polymer latex to an apparatus, the used amount of the acidic substance is preferably from 0.5 to 20 parts by weight, and particularly preferably from 5 to 15 parts by weight, based on 100 parts by weight (in terms of the solid content) of the rubber polymer latex.

The aromatic vinyl-based monomer which can be selected as the monomer (b-2) to be graft-polymerized with the butadiene-based rubber polymer (b-1) includes, for example, styrene, α-methylstyrene, p-methylstyrene, t-butylstyrene and dimethylstyrene, which can be used alone or in combination. Styrene is particularly preferred.

The vinyl cyanide-based monomer includes, for example, acrylonitrile and methacrylonitril, which can be used alone or in combination. Acrylonitrile is particularly preferred.

The (meth)acrylic acid ester-based monomer includes, for example, methyl (meth)acrylate, 2-ethylhexyl (meth)acrylate, ethyl (meth)acrylate and butyl (meth)acrylate, which can be used alone or in combination.

The maleimide-based monomer includes, for example, maleimide, methylmaleimide, ethylmaleimide and N-phenylmaleimide, which can be used alone or in combination.

In the present invention, as long as the effects of the present invention are not adversely affected, copolymerizable other vinyl-based monomers, for example, unsaturated carboxylic acids or anhydrides thereof (acrylic, methacrylic and maleic anhydrides) and amide-based monomers (acrylamide and methacrylamide) can be used in combination with the above monomers, and these monomers can be used alone or in combination.

The ratio of the butadiene-based rubber polymer (b-1) to the monomer (b-2) is not particularly limited as long as the objective resin composition of the present invention can be obtained. However, taking physical property balance with regard to such as impact resistance into consideration, the proportion of the butadiene-based rubber polymer (b-1) is preferably from 5 to 80% by weight and that of the monomer (b-2) is preferably from 95 to 20% by weight, based on the graft copolymer (B) (100% by weight).

A graft ratio of the graft copolymer (B) is not particularly limited as long as the objective resin composition of the present invention can be obtained. Taking physical property balance with regard to such as impact resistance into consideration, the graft ratio is preferably from 20 to 150%.

The method of graft polymerization of the butadiene-based rubber polymer (b-1) with the monomer (b-2) to obtain a graft copolymer (B) is not particularly limited as long as the objective resin composition of the present invention can be obtained, and known emulsion polymerization, bulk polymerization, solution polymerization and suspension polymerization methods can be used alone or in combination.

Next, a (co)polymer (C) according to inventions of one aspect and another aspect will be explained. The (co)polymer (C) can be obtained by polymerization of at least one monomer selected from the group consisting of an aromatic vinyl-based monomer, a vinyl cyanide-based monomer, a (meth)acrylic acid ester-based monomer and a maleimide-based monomer.

Examples of the aromatic vinyl-based monomer which can be selected so as to obtain the (co)polymer (C) include wuch as styrene, α-methylstyrene, p-methylstyrene, t-butylstyrene and dimethylstyrene, which can be used alone or in combination. Styrene is particularly preferred.

Examples of the vinyl cyanide-based monomer include such as acrylonitrile and methacrylonitrile, which can be used alone or in combination. Acrylonitrile is particularly preferred.

Examples of the (meth)acrylic acid ester-based monomer include such as methyl (meth)acrylate, 2-ethylhexyl (meth)acrylate, ethyl (meth)acrylate and butyl (meth)acrylate, which can be used alone or in combination.

Examples of the maleimide-based monomer include such as maleimide, methylmaleimide, ethylmaleimide and N-phenylmaleimide, which can be used alone or in combination.

In the present invention, as long as the effects of the present invention are not adversely affected, copolymerizable other vinyl-based monomers, for example, unsaturated carboxylic acids or anhydrides thereof (such as acrylic, methacrylic and maleic anhydrides) and amide-based monomers (such as acrylamide and methacrylamide) can be used in combination with the above monomers, and these monomers can be used alone or in combination.

The (co)polymer (C) preferably contains a polymer obtained by polymerization of a monomer including styrene, acrylonitrile, α-methylstyrene and/or a maleimide-based monomer, and more preferably a polymer obtained by polymerization of a monomer including α-methylstyrene and/or a maleimide-based monomer.

The (co)polymer (C) particularly preferably includes an acrylonitrile-styrene copolymer, a styrene-N-phenylmaleimide copolymer and/or a α-methylstyrene-acrylonitrile copolymer, and most preferably a styrene-N-phenylmaleimide copolymer and/or a α-methylstyrene-acrylonitrile copolymer.

In view of heat resistance of the thermoplastic resin composition for a vehicular lamp housing, the (co)polymer (C) preferably contains 5 parts by weight or more, more preferably 10 to 80 parts by weight, of a polymer obtained by polymerization of a monomer including α-methylstyrene and/or a maleimide-based monomer (provided that part(s) by weight is based on the (co)polymer (C) (100 parts by weight)). Therefore, the (co)polymer (C) preferably contains 95 parts by weight or less, and more preferably 90 to 20 parts by weight, of a polymer contained in the (co)polymer (C) other than the polymer obtained by polymerization of the monomer including α-methylstyrene and/or a maleimide-based monomer.

An inherent viscosity (measured at 25° C. by preparing an N,N-dimethylformamide solution (0.2 g/100 cc) of the (co)polymer (C) is not particularly limited, but is preferably from 0.2 to 1.2 because of excellent physical property balance of the thermoplastic resin composition for a vehicular lamp housing.

The method of producing the (co)polymer (C) is not particularly limited as long as the objective resin composition of the present invention can be obtained, and the (co)polymer (C) can be produced by using known emulsion polymerization, bulk polymerization, solution polymerization and suspension polymerization methods alone or in combination.

The thermoplastic resin composition for a vehicular lamp housing according to an invention of one aspect of the present invention contains 5 to 95 parts by weight of the above graft copolymer (A) and 95 to 5 parts by weight of the above (co)polymer (C) (provided that part(s) by weight is based on the total of (A) and (C) (100 parts by weight)). When the amount of the graft copolymer (A) is less than 5 parts by weight, it is not preferred because of poor impact resistance. When the amount is more than 95 parts by weight, it is not preferred because of poor moldability. It is preferred to contain 10 to 80 parts by weight of the graft copolymer (A) and 20 to 90 parts by weight of the (co)polymer (C) (provided that parts(s) is based on the total of (A) and (C) (100 parts by weight)).

The thermoplastic resin composition for a vehicular lamp housing according to an invention of another aspect of the present invention contains 5 to 90 parts by weight of the graft copolymer (A), 5 to 90 parts by weight of the graft copolymer (B) and 5 to 90 parts by weight of the (co)polymer (C) (provided that part(s) by weight is based on the total of (A), (B) and (C) (100 parts by weight)). When the proportion of the graft copolymer (A) is less than 5% by weight, it is not preferred because of poor impact resistance. When the proportion is more than 90 parts by weight, it is not preferred because of poor moldability and color development property. When the proportion of the graft copolymer (B) component is less than 5% by weight, impact resistance and color development property are poor. When the proportion is more than 90 parts by weight, moldability and gloss are poor. It is preferred to contain 5 to 70 parts by weight of the graft copolymer (A), 5 to 70 parts by weight of the graft copolymer (B) and 20 to 80 parts by weight of the (co)polymer (C) (provided that part(s) is based on the total of (A), (B) and (C) (100 parts by weight)).

The resin composition of the present invention preferably contains silicone oil in view of impact resistance. Examples of the silicone oil include such as dimethylsilicone oil, methylphenylsilicone oil, methylhydrogensilicone oil, polyethersilicone oil, amino-modified silicone oil and epoxy-modified silicone oil. The resin composition preferably contains 0.01 to 5 parts by weight, and more preferably 0.05 to 3 parts by weight, of the silicone oil based on the total of the thermoplastic resin composition for a vehicular lamp housing (100 parts by weight).

To the thermoplastic resin composition for a vehicular lamp housing of the present invention, if necessary, various additive such as known antioxidants, photostabilizers, lubricants, plasticizers, antistatic agents, colorants, flame retardants, delustering agents and fillers can be added.

The resin composition of the present invention can be obtained by mixing the above components. For example, known kneading machines such as an extruder, a roll, a Banbury mixer and a kneader can be used for mixing.

The thus obtained thermoplastic resin composition for a vehicular lamp housing of the present invention can be used alone, or can be optionally used in combination with other thermoplastic resins. Examples of other thermoplastic resins include such as a polycarbonate resin, a polybutylene terephthalate resin, a polyethylene terephthalate resin, a polyamide resin, a rubber-reinforced polystyrene resin (HIPS resin), an acrylonitrile-ethylene-propylene-styrene resin (AES resin) and a methyl methacrylate-butadiene-styrene resin (MBS resin).

Furthermore, the thermoplastic resin composition for a vehicular lamp housing of the present invention can be molded by known molding methods, for example, injection molding, blow molding and press molding methods, and various molded articles can be produced.

When a vehicular lamp housing molded article produced from the thermoplastic resin composition for a vehicular lamp housing of the present invention is welded with other members such as lens made of a resin produced by using resins such as polycarbonate and polymethyl methacrylate, a hot plate welding method, a vibration welding method or a laser welding method can be suitably used.

### EXAMPLES

While the following Examples and Comparative Examples further illustrate the present invention in detail, these are exemplary of the invention and are not to be considered as limiting. In Examples, parts and percentages are by weight.

Production of Aromatic Vinyl-Based Polymer Latex (a-1-1A)

In a nitrogen-substituted glass reactor, 270 parts by weight of deionized water, 2 parts by weight of styrene, 1 part by weight of butyl acrylate, 1 part (in terms of the solid content) of dipotassium alkenyl succinate (RATEMUL ASK, manufactured by Kao Corporation) and 0.2 part by weight of potassium persulfate were charged and then polymerized at 65° C. for 1 hour.

Thereafter, a monomer mixture of 78 parts by weight of styrene, 19 parts by weight of butyl acrylate and 0.5 part by weight of allyl methacrylate, and 30 parts by weight of an aqueous emulsifier solution containing 2 parts by weight (in terms of the solid content) of dipotassium alkenyl succinate (RATEMUL ASK, manufactured by Kao Corporation) were continuously added over 4 hours, followed by polymerization at 65° C. for 2 hours to obtain an aromatic vinyl-based polymer latex (a-1-1A).

The obtained polymer latex (a-1-1A) was freeze-dried by a cryo-transfer holder and an electron micrograph was taken by an electron microscope JEM-1400 manufactured by JEOL Ltd. Each particle area was measured by analyzing the electron micrograph using an image analyzer (device name: IP-1000PC, manufactured by Asahi Kasei Corporation) to obtain an equivalent circle diameter (diameter) of each particle, and thus a volume of each particle can be determined. A weight average particle diameter of a polymer latex (a-1-1A) was calculated by determining an average of the obtained volumes. As a result, the weight average particle diameter was 80 nm.

Production of Aromatic Vinyl-Based Polymer Latex (a-1-1B)

In a nitrogen-substituted glass reactor, 270 parts by weight of deionized water, 3 parts by weight of styrene, 1 part by weight of acrylonitrile, 1 part by weight (in terms of the solid content) of dipotassium alkenyl succinate (RATEMUL ASK, manufactured by Kao Corporation) and 0.2 part by weight of potassium persulfate were charged and then polymerized at 65° C. for 1 hour. Thereafter, a monomer mixture of 77 parts by weight of styrene, 19 parts by weight of acrylonitrile and 0.5 part by weight of allyl methacrylate, and 30 parts by weight of an aqueous emulsifier solution containing 2 parts by weight (in terms of the solid content) of dipotassium alkenyl succinate (RATEMUL ASK, manufactured by Kao Corporation) were continuously added over 4 hours, followed by polymerization at 65° C. for 2 hours to obtain an aromatic vinyl-based polymer latex (a-1-1B).

A weight average particle diameter of the obtained polymer latex (a-1-1B) was calculated in the same manner as in the polymer latex (a-1-1A). As a result, the weight average particle diameter was 110 nm.

Production of Aromatic Vinyl-Based Polymer Latex (a-1-1′C)

In a nitrogen-substituted glass reactor, 270 parts by weight of deionized water, 4 parts by weight of styrene, 2 parts by weight of butyl acrylate, 0.3 part by weight (in terms of the solid content) of dipotassium alkenyl succinate (RATEMUL ASK, manufactured by Kao Corporation) and 0.2 part by weight of potassium persulfate were charged and then polymerized at 65° C. for 1 hour. Thereafter, a monomer mixture of 76 parts by weight of styrene, 18 parts by weight of butyl acrylate and 0.5 part by weight of allyl methacrylate, and 30 parts by weight of an aqueous emulsifier solution containing 1.2 parts by weight (in terms of the solid content) of dipotassium alkenyl succinate (RATEMUL ASK, manufactured by Kao Corporation) were continuously added over 6 hours, followed by polymerization at 65° C. for 2 hours to obtain an aromatic vinyl-based polymer latex (a-1-1′C).

A weight average particle diameter of the obtained polymer latex (a-1-1′C) was calculated in the same manner as in the polymer latex (a-1-1A). As a result, the weight average particle diameter was 170 nm.

Production of Aromatic Vinyl-Based Polymer (a-1-1D)

In a nitrogen-substituted glass reactor, 270 parts by weight of deionized water, 2 parts by weight of styrene, 1 part by weight of butyl acrylate, 1 part (in terms of the solid content) of dipotassium alkenyl succinate (RATEMUL ASK, manufactured by Kao Corporation) and 0.2 part by weight of potassium persulfate were charged and then polymerized at 65° C. for 1 hour. Thereafter, a monomer mixture of 18 parts by weight of styrene, 79 parts by weight of butyl acrylate and 0.5 part by weight of allyl methacrylate, and 30 parts by weight of an aqueous emulsifier solution containing 2 parts by weight (in terms of the solid content) of dipotassium alkenyl succinate (RATEMUL ASK, manufactured by Kao Corporation) were continuously added over 3 hours, followed by polymerization at 65° C. for 2 hours to obtain an aromatic vinyl-based polymer (a-1-1D).

A weight average particle diameter of the obtained polymer latex (a-1-1D) was calculated in the same manner as in the polymer latex (a-1-1A). As a result, the weight average particle diameter was 40 nm.

Production of Acrylic Acid Ester-Based Rubbery Polymer Latex (a-1-2A)

In a nitrogen-substituted glass reactor, 150 parts by weight of deionized water, 10 parts by weight (in terms of the solid content) of the aromatic vinyl-based polymer latex (a-1-1A), 5 parts by weight of butyl acrylate, 0.05 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixed solution of 85 parts by weight of butyl acrylate and 0.45 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 4 hours, followed by polymerization at 65° C. for 3 hours to obtain an acrylic acid ester-based rubbery polymer latex (a-1-2A).

A weight average particle diameter of the obtained rubbery polymer latex (a-1-2A) was calculated in the same manner as in the polymer latex (a-1-1A). As a result, the weight average particle diameter was 180 nm.

Production of Acrylic Acid Ester-Based Rubbery Polymer Latex (a-1-2B)

In a nitrogen-substituted glass reactor, 120 parts by weight of deionized water, 20 parts by weight (in terms of the solid content) of the aromatic vinyl-based polymer latex (a-1-1A), 10 parts by weight of butyl acrylate, 0.10 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixture of 70 parts by weight of butyl acrylate and 0.40 parts by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 3.5 hours, followed by polymerization at 65° C. for 3 hours to obtain an acrylic acid ester-based rubbery polymer latex (a-1-2B).

A weight average particle diameter of the obtained rubbery polymer latex (a-1-2B) was calculated in the same manner as in the polymer latex (a-1-1A). As a result, the weight average particle diameter was 170 nm.

Production of Acrylic Acid Ester-Based Rubbery Polymer Latex (a-1-2C)

In a nitrogen-substituted glass reactor, 150 parts by weight of deionized water, 10 parts by weight (in terms of the solid content) of the aromatic vinyl-based polymer latex (a-1-1B), 5 parts by weight of butyl acrylate, 0.05 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixed solution of 85 parts by weight of butyl acrylate and 0.45 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 4 hours, followed by polymerization at 65° C. for 3 hours to obtain an acrylic acid ester-based rubbery polymer latex (a-1-2C).

A weight average particle diameter of the obtained rubbery polymer latex (a-1-2C) was calculated in the same manner as in the polymer latex (a-1-1A). As a result, the weight average particle diameter was 210 nm.

Production of Acrylic Acid Ester-Based Rubbery Polymer Latex (a-1-2′D)

In a nitrogen-substituted glass reactor, 150 parts by weight of deionized water, 10 parts by weight (in terms of the solid content) of the aromatic vinyl-based polymer latex (a-1-1A), 15 parts by weight of butyl acrylate, 0.15 part by weight of allyl methacrylate, 0.05 part by weight (in terms of the solid content) of dipotassium alkenyl succinate (RATEMUL ASK, manufactured by Kao Corporation) and 0.3 part by weight potassium persulfate were charged and then reacted at 65° C. for 1 hour. Thereafter, a mixed solution of 75 parts by weight of butyl acrylate and 0.35 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 3.5 hours, followed by polymerization at 65° C. for 3 hours to obtain an acrylic acid ester-based rubbery polymer latex (a-1-2′D).

A weight average particle diameter of the obtained rubbery polymer latex (a-1-2′D) was calculated in the same manner as in the polymer latex (a-1-1A). As a result, the weight average particle diameter was 300 nm.

Production of Acrylic Acid Ester-Based Rubbery Polymer Latex (a-1-2′E)

In a nitrogen-substituted glass reactor, 30 parts by weight of deionized water, 50 parts by weight (in terms of the solid content) of the aromatic vinyl-based polymer latex (a-1-1A), 20 parts by weight of butyl acrylate, 0.20 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1.5 hours. Thereafter, a mixed solution of 30 parts by weight of butyl acrylate and 0.30 part by weight of allyl methacrylate, and an aqueous emulsifier solution prepared by dissolving 0.15 part by weight (in terms of the solid content) of dipotassium alkenyl succinate (RATEMUL ASK, manufactured by Kao Corporation) in 20 parts by weight of deionized water were continuously added over 2 hours, followed by polymerization at 65° C. for 3 hours to obtain an acrylic acid ester-based rubbery polymer latex (a-1-2′E).

A weight average particle diameter of the obtained rubbery polymer latex (a-1-2′E) was calculated in the same manner as in the polymer latex (a-1-1A). As a result, the weight average particle diameter was 150 nm.

Production of Acrylic Acid Ester-Based Rubbery Polymer Latex (a-1-2′F)

In a nitrogen-substituted glass reactor, 180 parts by weight of deionized water, 15 parts by weight of butyl acrylate, 0.15 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixed solution of 85 parts by weight of butyl acrylate and 0.35 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 4 hours, followed by polymerization at 65° C. for 3 hours to obtain an acrylic acid ester-based rubbery polymer latex (a-1-2′F).

A weight average particle diameter of the obtained rubbery polymer latex (a-1-2′F) was calculated in the same manner as in the polymer latex (a-1-1A). As a result, the weight average particle diameter was 180 nm.

Production of Acrylic Acid Ester-Based Rubbery Polymer Latex (a-1-2′G)

In a nitrogen-substituted glass reactor, 150 parts by weight of deionized water, 10 parts by weight (in terms of the solid content) of the aromatic vinyl-based polymer latex (a-1-1′C), 5 parts by weight of butyl acrylate, 0.05 part by weight of allyl methacrylate, 0.15 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixed solution of 85 parts by weight of butyl acrylate and 0.35 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 4 hours, followed by polymerization at 65° C. for 3 hours to obtain an acrylic acid ester-based rubbery polymer latex (a-1-2G).

A weight average particle diameter of the obtained rubbery polymer latex (a-1-2G) was calculated in the same manner as in the polymer latex (a-1-1A). As a result, the weight average particle diameter was 230 nm.

Production of Acrylic Acid Ester-Based Rubbery Polymer Latex (a-1-2′H)

In a nitrogen-substituted glass reactor, 150 parts by weight of deionized water, 10 parts by weight (in terms of the solid content) of the aromatic vinyl-based polymer latex (a-1-1D), 5 parts by weigh of butyl acrylate, 0.05 part by weight of allyl methacrylate, 0.05 part by weight (in terms of the solid content) of dipotassium alkenyl succinate (RATEMUL ASK, manufactured by Kao Corporation) and 0.3 part by weight of potassium persulfate were charged and then reacted at 65° C. for 1 hour. Thereafter, a mixed solution of 85 parts by weight of butyl acrylate and 0.45 part by weight of allyl methacrylate, and an aqueous emulsifier solution prepared by dissolving 0.45 part by weight (in terms of the solid content) of dipotassium alkenyl succinate (RATEMUL ASK, manufactured by Kao Corporation) in 20 parts by weight of deionized water were continuously added over 4 hours, followed by polymerization at 65° C. for 3 hours to obtain an acrylic acid ester-based rubbery polymer latex (a-1-2′H).

A weight average particle diameter of the obtained rubbery polymer latex (a-1-2′H) was calculated in the same manner as in the polymer latex (a-1-1A). As a result, the weight average particle diameter was 60 nm.

Production of the acrylic acid ester-based rubbery polymers (a-1-2A to a-1-2C and a-1-2′D to a-1-2′H) was summarized in Table 1.

TABLE 1

| | | Acrylic acid ester-based rubbery polymer | | | | | | | |
|---|---|---|---|---|---|---|---|---|---|
| | | a-1-2A | a-1-2B | a-1-2C | a-1-2′D | a-1-2′E | a-1-2′F | a-1-2′G | a-1-2′H |
| | | Aromatic vinyl-based polymer | | | | | | | |
| | | a-1-1A | a-1-1A | a-1-1B | a-1-1A | a-1-1A | — | a-1-1′C | a-1-1D |
| Butyl acrylate | Parts | 2 | 4 | | 2 | 10 | | 2 | 8 |
| Acrylonitrile | Parts | | | 2 | | | | | |
| Styrene | Parts | 8 | 16 | 8 | 8 | 40 | | 8 | 2 |
| Weight average particle diameter | nm | 80 | 80 | 110 | 80 | 80 | — | 170 | 40 |
| Acrylic acid ester-based monomer | Parts | 90 | 80 | 90 | 90 | 50 | 100 | 90 | 90 |
| Acrylic acid ester-based rubbery | nm | 180 | 170 | 210 | 300 | 150 | 180 | 230 | 60 |
| polymer | | | | | | | | | |
| Weight average particle diameter | | | | | | | | | |

### Production of Graft Copolymer (A-1)

In a nitrogen-substituted glass reactor, 50 parts by weight (in terms of the solid content) of the acrylic acid ester-based rubber polymer latex (a-1-2A), and an aqueous solution prepared by dissolving 100 parts by weight of deionized water, 0.2 part by weight of lactose, 0.1 part by weight of anhydrous sodium pyrophosphate and 0.005 part by weight of ferrous sulfate were charged and then heated to 70° C. Thereafter, a mixed solution of 15 parts by weight of acrylonitrile, 35 parts by weight of styrene, 0.05 part of tertiary dodecylmercaptan and 0.3 part by weight of cumen hydroperoxide, and an aqueous emulsifier solution prepared by dissolving 1.0 part by weight of potassium oleate in 20 parts by weight of deionized water were continuously added over 4 hours, followed by polymerization at 70° C. for 3 hours. After salting-out, dehydration and drying, a graft copolymer (A-1) was obtained.

### Production of Graft Copolymers (A-2 to A-3 and A′-4 to A′-8)

In the same manner as in the graft copolymer (A-1), except that the acrylic acid ester-based rubber polymer latex, styrene and acrylonitrile were changed as shown in Table 2, graft copolymers (A-2 to A-3 and A′-4 to A′-8) were obtained.

TABLE 2

| Composition of graft copolymer | | A-1 | A-2 | A-3 | A′-4 | A′-5 | A′-6 | A′-7 | A′-8 |
|---|---|---|---|---|---|---|---|---|---|
| Rubbery polymer | | | | | | | | | |
| a-1-2A | Parts | 50 | | | | | | | |
| a-1-2B | Parts | | 60 | | | | | | |
| a-1-2C | Parts | | | 50 | | | | | |
| a-1-2′D | Parts | | | | 50 | | | | |
| a-1-2′E | Parts | | | | | 50 | | | |
| a-1-2′F | Parts | | | | | | 50 | | |
| a-1-2′G | Parts | | | | | | | 50 | |
| a-1-2′H | Parts | | | | | | | | 60 |
| Monomer a-2 | | | | | | | | | |
| Acrylonitrile | Parts | 15 | 12 | 15 | 15 | 15 | 15 | 15 | 12 |
| Styrene | Parts | 35 | 28 | 35 | 35 | 35 | 35 | 35 | 28 |

Production of Butadiene-Based Rubber Polymer Latex (b-1A)

After substituting an atmosphere inside a 10 liter pressure vessel with nitrogen, 100 parts by weight of 1,3-butadiene, 0.5 part by weight of n-dodecylmercaptan, 0.3 part by weight of potassium persulfate, 0.8 part by weight of disproportionated sodium rosinate, 0.1 part by weight of sodium hydroxide and 130 parts by weight of deionized water were charged in the pressure vessel and then reacted at 70° C. for 20 hours while stirring. Thereafter, 0.6 part by weight of disproportionated sodium rosinate, 0.1 part by weight of sodium hydroxide and 5 parts by weight of deionized water were added. After a lapse of 10 hours while maintaining the temperature at 70° C., 0.6 part by weight of disproportionated sodium rosinate, 0.1 part by weight of sodium hydroxide and 5 parts by weight of deionized water were added and the stirring was continued at 70° C. for 5 hours, and then the reaction was completed. Thereafter, remaining 1,3-butadiene was removed under reduced pressure to obtain a butadiene-based rubber polymer latex (b-1A).

A weight average particle diameter of the obtained rubber polymer latex (b-1A) was calculated in the same manner as in the polymer latex (a-1-1A). As a result, the weight average particle diameter was 330 nm.

Production of Butadiene-Based Rubber Polymer Latex (b-1′B)

After substituting an atmosphere inside a 10 liter pressure vessel with nitrogen, 100 parts by weight of 1,3-butadiene, 0.5 part by weight of n-dodecylmercaptan, 0.3 part by weight of potassium persulfate, 1.8 parts by weight of disproportionated sodium rosinate, 0.1 part by weight of sodium hydroxide and 145 parts by weight of deionized water were charged in the pressure vessel and then reacted at 70° C. for 8 hours while stirring. Thereafter, 0.2 part by weight of disproportionated sodium rosinate, 0.1 part by weight of sodium hydroxide and 5 parts by weight of deionized water were added. Furthermore, the stirring was continued for 6 hours while maintaining the temperature at 70° C. and then the reaction was completed. Thereafter, remaining 1,3-butadiene was removed under reduced pressure to obtain a butadiene-based rubber polymer latex (b-1′B).

A weight average particle diameter of the obtained rubber polymer latex (b-1′B) was calculated in the same manner as in the polymer latex (a-1-1A). As a result, the weight average particle diameter was 120 nm.

Production of Butadiene-Based Rubber Polymer Latex (b-1C)

In a 10 liter pressure vessel, 270 parts by weight (in terms of the solid content) of the butadiene-based rubber polymer latex (b-1′B) and 0.1 part by weight of sodium dodecylbenzene sulfonate were added. After mixing with stirring for 10 minutes, 20 parts by weight of an aqueous 5% phosphoric acid solution was added over 10 minutes. Thereafter, 10 parts by weight of an aqueous 10% potassium hydroxide solution 1 was added to obtain an aggregated and enlarged butadiene-based rubber polymer latex (b-1C).

A weight average particle diameter of the obtained rubber polymer latex (b-1C) was calculated in the same manner as in the polymer latex (a-1-1A). As a result, the weight average particle diameter was 330 nm.

Production of Butadiene-Based Rubber Polymer Latex (b-1′D)

In a 10 liter pressure vessel, 270 parts by weight (in terms of the solid content) of the butadiene-based rubber polymer latex (b-1′B) and 0.03 parts by weight of sodium dodecylbenzene sulfonate were added. After mixing with stirring for 10 minutes, 20 parts by weight of an aqueous 5% phosphoric acid solution was added over 30 minutes. Thereafter, 10 parts by weight of an aqueous 10% potassium hydroxide solutionl was added to obtain an aggregated and enlarged butadiene-based rubber polymer latex (b-1′D).

A weight average particle diameter of the obtained rubber polymer latex (b-1′D) was calculated in the same manner as in the polymer latex (a-1-1A). As a result, the weight average particle diameter was 460 nm.

### Production of Graft Copolymer (B-1)

In a nitrogen-substituted glass reactor, 50 parts by weight (in terms of the solid content) of the butadiene-based rubber polymer latex (b-1A), and an aqueous solution prepared by dissolving 100 parts by weight of deionized water, 0.2 part by weight of lactose, 0.1 part by weight of anhydrous sodium pyrophosphate and 0.005 parts by weight of ferrous sulfate were charged and then heated to 70° C. Thereafter, a mixture of 13 parts by weight of acrylonitrile, 37 parts by weight of styrene, 0.15 parts of tertiary dodecylmercaptan and 0.3 part by weight of cumen hydroperoxide and an aqueous emulsifier solution prepared by dissolving 1.0 part by weight of potassium oleate in 20 parts by weight of deionized water were continuously added over 3 hours, followed by polymerization at 70° C. for 2 hours. Thereafter, the obtained reaction mixture was salted-out, dehydrated and then dried to obtain a graft copolymer (B-1).

In the same manner as in the production of the graft copolymer (B-1), except that the butadiene-based rubber polymer latex, and styrene and acrylonitrile as monomers were changed as shown in Table 3, graft copolymers (B′-2, B-3 and B′-4) were obtained.

TABLE 3

| Graft copolymer | | B-1 | B′-2 | B-3 | B′-4 |
|---|---|---|---|---|---|
| Rubber polymer | | | | | |
| b-1A | Parts | 50 | | | |
| b-1′B | Parts | | 60 | | |
| b-1C | Parts | | | 50 | |
| b-1′D | Parts | | | | 60 |
| Rubber particle | nm | 330 | 120 | 330 | 460 |
| diameter | | | | | |
| Ramarks | | | | Aggregation | Aggregation |
| | | | | and | and |
| | | | | enlargement | enlargement |
| | | | | of b-1′B | of b-1′B |
| Monomer b-2 | | | | | |
| Acrylonitrile | Parts | 13 | 10 | 13 | 10 |
| Styrene | Parts | 37 | 30 | 37 | 30 |

As the copolymer (C), the following resins were used.

AS resin: acrylonitrile-styrene copolymer (LITAC-A 230PCU (trade name), manufactured by NIPPON A&L INC.)
STY-imide resin: styrene-N-phenylmaleimide copolymer (DENKA IP MS-NC (trade name), manufactured by DENKI KAGAKU KOGYO KABUSHIKI KAISHA)
AMS-AN resin: A monomer mixture of 70% by weight of a-methylstyrene and 30% by weight of acrylonitrile was polymerized by a known emulsion polymerization method to obtain an AMS-AN resin.

As silicone oil, dimethylsilicone oil (SH-200-100CS (trade name), viscosity: 100 cP (23° C.), manufactured by Dow Corning Toray Co., Ltd.) was used.

### Examples 1 to 4, 10 to 14 and Comparative Examples 1 to 9

Components shown in Tables 4 to 6 were mixed according to each formulation shown in Tables 4 to 6 and then each mixture was pelletized by melt-kneading at 240° C. using a 40 mm twin screw extruder. Using the obtained pellets, test pieces of Examples 1 to 4, 10 to 14 and Comparative Examples 1 to 9 were produced in accordance with Method of Testing defined in ISO 294, and then (1) impact resistance and (2) fluidity were evaluated.

### (1) Impact Resistance

Impact resistance of a test piece was evaluated by measuring a notched Sharpy impact value (4 mm in thickness) in accordance with ISO 179. Unit: kJ/m²

### (2) Fluidity

Fluidity of a test piece was evaluated by measuring a melt volume flow rate in accordance with ISO 1133. Unit: cm³/10 min.

Components shown in Tables 4 to 6 were mixed according to each formulation shown in Tables 4 to 6 and mixed with 1.0 part by weight of Carbon #45B (Mitsubishi Chemical Corporation) and then each mixture was melt-kneaded at 240° C. using a 40 mm twin screw extruder to obtain colored pellets. Using an injection molder set at 250° C., the obtained colored pellets were molded to obtain a molded article (measuring 150 mm×120 mm×3 mm) and then (3) gloss and (4) color development property were evaluated.

### (3) Gloss

Gloss of a molded article was evaluated by measuring surface gloss in accordance with ASTM D-523. Unit: %

### (4) Color Development Property

Color development property of a molded article was evaluated by measuring blackness (ebony) of the molded article due to hue measurement in accordance with JIS Z8729.

### (5) Hot Plate Weldability

The colored pellets of Examples 1 to 4, 10 to 14, and Comparative Examples 1 to 9 were injection-molded under the conditions of a cylinder temperature of 240° C. and a mold temperature of 50° C. using an injection molder to produce an ASTM No. 1 dumbbell for evaluation of hot plate weldability. The above dumbbell was pressed against an aluminum flat plate heated at 280° C. under a pressure of 10 kgf/cm² for 30 seconds. Then, it was judged whether or not stringiness occurs on a weld surface when the dumbbell is pull up at a speed of 500 mm/min.

A: no stringiness

B: slight stringiness

C: some stringiness

### (6) Vibration Weldability

Using an injection molder, the colored pellets of Examples 1 to 4, 10 to 14, and Comparative Examples 1 to 9 were injection-molded under the conditions of a cylinder temperature of 240° C. to obtain a molded article (150 mm in width×90 mm in length×3 mm in thickness) for evaluation of vibration welding. Also, a polymethyl methacrylate resin (“SUMIPEX MHF” (trade name), manufactured by Sumitomo Chemicals Co., Ltd.) as a material for evaluation lens was injection-molded to obtain a molded article having a box shape (120 mm in width×180 mm in length×20 mm in height×3 mm in thickness). Using BRANSON VIBRATION WELDER Model 2406 manufactured by Emerson Japan, Ltd., the molded article obtained from the material for evaluation lens and the molded article for evaluation of vibration welding were subjected to vibration welding under vibration welding conditions of an amplitude of 0.5 mm, a pressure of 0.24 MPa and a sink quantity of 1.0 mm.

The evaluation results of appearance of the weld portion were shown by three ranks (A, B and C) in the order of increasing spread of a thermoplastic resin at burrs of the weld portion.

### (7) Laser Weldability

A laser-transmitting material and a laser-absorbing material are required to perform laser welding. A polymethyl methacrylate resin (“SUMIPEX MHF” (trade name), manufactured by Sumitomo Chemicals Co., Ltd.) as a laser-transmitting side material was injection-molded at 240° C. to obtain a test piece measuring 2 mm in thickness×55 mm in width×90 mm in length of the laser-transmitting side material.

Components shown in Tables 4 to 6 as a laser-absorbing side material were mixed according to each formulation shown in Tables 4 to 6 and carbon black Carbon #45B (manufactured by Mitsubishi Chemical Corporation) and titanium oxide were added to each mixture, and then the mixture was melt-kneaded at 240° C. using a 40 mm twin screw extruder to obtain colored pellets. The addition amounts of carbon black and titanium oxide were appropriately adjusted so that all colored pellets of Examples 1 to 4, 10 to 14, and Comparative Examples 1 to 9 show the same hue. The hue of a standard plate having the same hue is as follows: L* (D65)=41, a (D65)=3, and b (D65)=−10 (measured by spectrophotometer CMS-35SP, manufactured by MURAKAMI COLOR RESEARCH LABORATORY CO., LTD.). The obtained colored pellets were injection-molded in the same manner as in the laser-transmitting side material to obtain a test piece measuring 2 mm in thickness×55 mm in width×90 mm in length.

The thus obtained laser-transmitting side test piece and laser-transmitting side test piece were set to a jig so that short side sections overlap with each other so as to have an overlapping margin of 25 mm×55 mm in width, and then welded under the following conditions so as to have a weld seam width of 1 mm.

Welding was performed by irradiation from the laser-transmitting side test piece under the conditions of a laser beam wavelength of 808 nm, an output of 6 W and a scanning speed of 6 mm/s.

The obtained laser welded test piece was subjected to a tensile shear test using Autograph AGS-5KN manufactured by Shimadzu Corporation. A testing speed was set at 50 mm/min and a distance between chucks was set at 135 mm.

Strength and welding marks of a laser weld surface in a tensile shear test were evaluated according to the following criteria.

A: Weld (bond) strength is satisfactory, and welding marks (burn marks) are not observed on a weld surface.

B: Weld (bond) strength is satisfactory, and slight welding marks (burn marks) are observed on a weld surface.

C: Weld (bond) strength is low, and welding marks (burn marks) are observed on a surface or drastic color difference is observed on a weld surface.

The evolution results of the resin compositions according to Examples 1 to 4 and 10 to 14, and Comparative Examples 1 to 9 were summarized in Tables 4 to 6.

TABLE 4

| Examples | 1 | 2 | 3 | 4 |
|---|---|---|---|---|
| <Composition> | | | | |
| Graft polymer (A) | | | | |
| A-1 | 40 | | | |
| A-2 | | 33.3 | | |
| A-3 | | | 40 | 40 |
| Copolymer (C) | | | | |
| AS resin | 40 | 16.7 | 40 | 40 |
| STY-imide resin | 20 | | 20 | 20 |
| AMS-AN resin | | 50 | | |
| Silicone oil | 0.1 | 0.1 | 0.1 | |
| <Characteristics> | | | | |
| (1) Impact resistance (KJ/m²) | 10 | 10 | 11 | 9 |
| (2) Fluidity (cm³/10 min) | 9 | 8 | 9 | 9 |
| (5) Hot plate weldability | A | A | A | A |
| (6) Vibration weldability | A | A | A | B |
| (7) Laser weldability | A | A | A | A |

TABLE 5

| Examples | 10 | 11 | 12 | 13 | 14 |
|---|---|---|---|---|---|
| <Composition> | | | | | |
| Graft polymer (A) | | | | | |
| A-1 | 20 | 20 | | | |
| A-2 | | | 17 | | |
| A-3 | | | | 20 | 20 |
| Graft polymer (B) | | | | | |
| B-1 | 20 | | | 20 | 20 |
| B-3 | | 20 | 10 | | |
| Copolymer (C) | | | | | |
| AS resin | 40 | 40 | 20 | 40 | 40 |
| STY-imide resin | 20 | 20 | | 20 | 20 |
| AMS-AN resin | | | 53 | | |
| Silicone oil | | | | | 0.1 |
| <Characteristics> | | | | | |
| (1) Impact resistance (KJ/m²) | 16 | 15 | 8 | 11 | 13 |
| (2) Fluidity (cm³/10 min) | 9 | 10 | 6 | 12 | 12 |
| (3) Gloss (%) | 99.2 | 99.4 | 99.8 | 99.1 | 99.1 |
| (4) Ebony | 4.8 | 4.4 | 3.7 | 4.2 | 4.2 |
| (Color development property) | | | | | |
| Lightness index L* | | | | | |
| (5) Hot plate weldability | A | A | A | A | A |
| (6) Vibration weldability | A | A | A | A | B |
| (7) Laser weldability | A | A | A | A | A |

TABLE 6

| Comparative Examples | 1 | 2 | 3 | 4 | 5 | 6 | 7 | 8 | 9 |
|---|---|---|---|---|---|---|---|---|---|
| <Composition> | | | | | | | | | |
| Graft polymer (A) | | | | | | | | | |
| A-1 | | | | | | 20 | | | |
| A-2 | | | | | | | 20 | | |
| A′-4 | 40 | | | | | | | 20 | |
| A′-5 | | 40 | | | | | | | |
| A′-6 | | | 40 | | | | | | |
| A′-7 | | | | 40 | | | | | |
| A′-8 | | | | | 40 | | | | 20 |
| Graft polymer (B) | | | | | | | | | |
| B-1 | | | | | | | | 20 | |
| B′-2 | | | | | | 20 | | | |
| B-3 | | | | | | | | | 20 |
| B′-4 | | | | | | | 20 | | |
| Copolymer (C) | | | | | | | | | |
| AS resin | 40 | 40 | 40 | 40 | 40 | 40 | 20 | 40 | 20 |
| STY-imide resin | 20 | 20 | 20 | 20 | 20 | 20 | | 20 | |
| AMS-AN resin | | | | | | | 40 | | 40 |
| <Characteristics> | | | | | | | | | |
| (1) Impact resistance | 13 | 7 | 9 | 6 | 3 | 6 | 12 | 17 | 7 |
| (KJ/m²) | | | | | | | | | |
| (2) Fluidity (cm³/10 min) | 6 | 7 | 9 | 7 | 7 | 6 | 7 | 7 | 6 |
| (3) Gloss (%) | 97.5 | 90.3 | 98.6 | 91.2 | 92.5 | 85.1 | 97.1 | 98.6 | 92.6 |
| (4) Ebony | 5.2 | 4.2 | 5.5 | 5.4 | 6.1 | 8.1 | 7.3 | 6.7 | 5.7 |
| (Color development property) | | | | | | | | | |
| Lightness index L* | | | | | | | | | |
| (5) Hot plate weldability | A | C | A | C | C | B | A | A | C |
| (6) Vibration weldability | A | C | B | B | C | B | A | A | C |
| (7) Laser weldability | C | B | C | C | C | C | C | C | C |

As shown in Table 4, Examples 1 to 4 are examples of thermoplastic resin compositions for a vehicular lamp housing according to an invention of one aspect, and showed satisfactory hot plate weldability, vibration weldability and laser weldability and were excellent in physical property balance with reagrd to such as impact resistance and fluidity.

As shown in Table 5, Examples 10 to 14 are examples of thermoplastic resin compositions for a vehicular lamp housing according to an invention of another aspect, and showed satisfactory hot plate weldability, vibration weldability and laser weldability, and were also excellent in physical property balance with regard to such as impact resistance, fluidity and color development property.

Using the thermoplastic resin composition for a vehicular lamp housing of the present invention, a vehicular lamp housing was produced and then vibration weldability, hot plate weldability and laser weldability of a molded article at the lens side produced from a polycarbonate resin and a polymethyl methacrylate resin were evaluated. As a result, there was no problem for weldability.

Comparative Example 1 showed poor color development property and laser weldability because a weight average particle diameter of an acrylic acid ester-based rubbery polymer is 300 nm and exceeds the upper limit of the present invention.

Comparative Example 2 showed poor gloss, hot plate weldability and vibration weldability because an addition amount of an aromatic vinyl-based polymer is 50% by weight and exceeds the upper limit of the present invention.

Comparative Example 3 showed poor color development property, vibration weldability and laser weldability because an aromatic vinyl-based polymer was not used.

Comparative Example 4 showed poor impact resistance, fluidity, gloss, color development property, hot plate weldability, vibration weldability and laser weldability because a weight average particle diameter of an aromatic vinyl-based polymer is 170 nm and exceeds the upper limit of the present invention.

Comparative Example 5 showed poor impact resistance, fluidity, gloss, color development property, hot plate weldability, vibration weldability and laser weldability because a weight average particle diameter of an acrylic acid ester-based rubbery polymer is 60 nm and is less than the lower limit of the present invention.

Comparative Example 6 showed poor physical property balance, hot plate weldability, vibration weldability and laser weldability because a weight average particle diameter of a butadiene-based rubbery polymer is 120 nm and is less than the lower limit of the present invention.

Comparative Example 7 showed improved impact resistance, but showed poor color development property and laser weldability because a weight average particle diameter of a butadiene-based rubbery polymer is 460 nm and a graft copolymer (B), which does not fall within a scope of the present invention, is used.

In Comparative Example 8, a graft copolymer (B), which falls within a scope of the present invention, is used. However, a weight average particle diameter of an acrylic acid ester-based rubbery polymer is 300 nm and a graft copolymer (A), which exceeds the upper limit of the present invention, is used. Therefore, impact resistance was improved, but color development property and laser weldability were poor.

Comparative Example 9 showed poor gloss, color development property, hot plate weldability, vibration weldability and laser weldability because a graft copolymer (A), which does not fall within a scope of the present invention, is used although a graft copolymer (B), which falls within a scope of the present invention, is used similar to Comparative Example 8.

### INDUSTRIAL APPLICABILITY

The thermoplastic resin composition for a vehicular lamp housing of the present invention is excellent in hot plate weldability, vibration weldability, laser weldability and balance of various physical properties, and is suited for use as a vehicular lamp housing material in which a transparent lens made of a resin and a lamp housing are integrally bonded by various welding methods.

### RELATED APPLICATIONS

This application claims priority under the Paris Convention or Article 41 of the Japanese Patent Law based on Japanese Patent Application No. 2008-232087 filed on Sep. 10, 2008 and Japanese Patent Application No. 2009-140918 filed on Jun. 12, 2009 in Japan, the disclosure of which is incorporated by reference herein.

1-11. (canceled)

12. A thermoplastic resin composition for a vehicular lamp housing, which comprises:
a graft copolymer (A) and a (co)polymer (C) shown below, wherein
the graft copolymer (A) is obtained by emulsion graft polymerization of an acrylic acid ester-based rubbery polymer (a-1-2) having a weight average particle diameter of 70 to 250 nm, which is obtained by emulsion polymerization of 60 to 95% by weight of an acrylic acid ester-based monomer in the presence of 5 to 40% by weight of an aromatic vinyl-based polymer (a-1-1) having a weight average particle diameter of 10 to 150 nm (provided that percentage(s) by weight is based on the acrylic acid ester-based rubbery polymer (a-1-2) (100% by weight)), with at least one monomer (a-2) selected from the group consisting of an aromatic vinyl-based monomer, a vinyl cyanide-based monomer, a (meth)acrylic acid ester-based monomer and a maleimide-based monomer;
the (co)polymer (C) is obtained by polymerization of at least one monomer selected from the group consisting of an aromatic vinyl-based monomer, a vinyl cyanide-based monomer, a (meth)acrylic acid ester-based monomer and a maleimide-based monomer;
the thermoplastic resin composition contains 5 to 95 parts by weight of the graft copolymer (A) and 5 to 95 parts by weight of the (co)polymer (C) (provided that part(s) by weight is based on the total of (A) and (C) (100 parts by weight));
the content of the acrylic acid ester-based rubbery polymer (a-1-2) is from 5 to 30% by weight of (provided that percentage(s) by weight is based on the resin composition (100% by weight)); and
wherein the aromatic vinyl-based polymer (a-1-1) is a polymer obtained by polymerization of a monomer containing 40 to 90% by weight of an aromatic vinyl-based monomer and 10 to 60% by weight of an acrylic acid ester-based monomer (provided that percentage(s) by weight is based on the total of the aromatic vinyl-based monomer and the acrylic acid ester-based monomer (100% by weight)), or
wherein the aromatic vinyl-based polymer (a-1-1) is a polymer obtained by polymerization of a monomer containing 40 to 90% by weight of an aromatic vinyl-based monomer and 10 to 60% by weight of a vinyl cyanide-based monomer (provided that percentage(s) by weight is based on the total of the aromatic vinyl-based monomer and the vinyl cyanide-based monomer (100% by weight)).

13. A thermoplastic resin composition for a vehicular lamp housing, which comprises:
a graft copolymer (A), a graft copolymer (B) and a (co)polymer (C) shown below, wherein
the graft copolymer (A) is obtained by emulsion graft polymerization of an acrylic acid ester-based rubbery polymer (a-1-2) having a weight average particle diameter of 70 to 250 nm, which is obtained by emulsion polymerization of 60 to 95% by weight of an acrylic acid ester-based monomer in the presence of 5 to 40% by weight of an aromatic vinyl-based polymer (a-1-1) having a weight average particle diameter of 10 to 150 nm (provided that percentage(s) by weight is based on the acrylic acid ester-based rubbery polymer (a-1-2) (100% by weight)), with at least one monomer (a-2) selected from the group consisting of an aromatic vinyl-based monomer, a vinyl cyanide-based monomer, a (meth)acrylic acid ester-based monomer and a maleimide-based monomer;
the graft copolymer (B) is obtained by graft polymerization of a butadiene-based rubber polymer (b-1) having a weight average particle diameter of 150 to 400 nm with at least one monomer (b-2) selected from the group consisting of an aromatic vinyl-based monomer, a vinyl cyanide-based monomer, a (meth)acrylic acid ester-based monomer and a maleimide-based monomer;
the (co)polymer (C) is obtained by polymerization of at least one monomer selected from the group consisting of an aromatic vinyl-based monomer, a vinyl cyanide-based monomer, a (meth)acrylic acid ester-based monomer and a maleimide-based monomer;
the thermoplastic resin composition contains 5 to 90 parts by weight of the graft copolymer (A), 5 to 90 parts by weight of the graft copolymer (B) and 5 to 90 parts by weight of the (co)polymer (C) (provided that part(s) by weight is based on the total of (A), (B) and (C) (100 parts by weight)); and
the total of the content of the acrylic acid ester-based rubbery polymer (a-1-2) and the content of the butadiene-based rubber polymer (b-1) is from 5 to 30% by weight (provided that percentage(s) by weight is based on the resin composition (100% by weight)).

14. The thermoplastic resin composition for a vehicular lamp housing according to claim 13, wherein the butadiene-based rubber polymer (b-1) contains a butadiene-based rubber polymer latex having a weight average particle diameter of 150 to 400 nm which is obtained by aggregating and enlarging a butadiene-based rubber polymer for aggregation and enlargement having a weight average particle diameter of 50 to 200 nm.

15. The thermoplastic resin composition for a vehicular lamp housing according to claim 13 or 14, wherein the butadiene-based rubber polymer (b-1) contains a butadiene-based rubber polymer latex which is obtained by adding an acidic substance to a butadiene-based rubber polymer latex for aggregation and enlargement having a weight average particle diameter of 50 to 200 nm thereby making the pH of the latex to be lower than 7, aggregating and enlarging the latex thereby adjust to have a weight average particle diameter of 150 to 400 nm, and adding a basic substance thereby making the pH to be higher than 7 and stabilizing the latex.

16. The thermoplastic resin composition for a vehicular lamp housing according to claim 13, wherein the aromatic vinyl-based polymer (a-1-1) is a polymer obtained by polymerization of a monomer containing 40 to 90% by weight of an aromatic vinyl-based monomer and 10 to 60% by weight of an acrylic acid ester-based monomer (provided that percentage(s) by weight is based on the total of the aromatic vinyl-based monomer and the acrylic acid ester-based monomer (100% by weight)).

17. The thermoplastic resin composition for a vehicular lamp housing according to claim 13, wherein the aromatic vinyl-based polymer (a-1-1) is a polymer obtained by polymerization of a monomer containing 40 to 90% by weight of an aromatic vinyl-based monomer and 10 to 60% by weight of a vinyl cyanide-based monomer (provided that percentage(s) by weight is based on the total of the aromatic vinyl-based monomer and the vinyl cyanide-based monomer (100% by weight)).

18. The thermoplastic resin composition for a vehicular lamp housing according to claim 12 or 13, wherein the (co)polymer (C) contains a polymer obtained by polymerization of a monomer including styrene, acrylonitrile, α-methylstyrene and/or a maleimide-based monomer.

19. The thermoplastic resin composition for a vehicular lamp housing according to claim 12 or 13, wherein the (co)polymer (C) contains 5 parts by weight or more of a polymer obtained by polymerization of a monomer including α-methylstyrene and/or a maleimide-based monomer (provided that part(s) by weight is based on the (co)polymer (C) (100 parts by weight)).

20. The thermoplastic resin composition for a vehicular lamp housing according to claim 12 or 13, wherein the resin composition contains 0.01 to 5 parts by weight of a silicone oil (provided that part(s) by weight is based on the total of the graft copolymer (A) and the (co)polymer (C) (100 parts by weight) or the total of the graft copolymer (A), the graft copolymer (B) and the (co)polymer (C) (100 parts by weight)).

21. The thermoplastic resin composition for a vehicular lamp housing according to claim 12 or 13, wherein the resin composition is used to produce a molded article which is welded with other members by means of a hot plate welding method, a vibration welding method or a laser welding method.

22. A molded article produced from the thermoplastic resin composition for a vehicular lamp housing according to claim 12 or 13.
